(19) United States
(12) Patent Application Publication
(10) Pub. No.: US 2015/0086744 A1
(43) Pub. Date: Mar. 26, 2015

(54) Label With Detachable Ticket

(71) Applicant: Frito-Lay North America, Inc., Plano, TX (US)

(72) Inventor: Benjamin Adam Avis, Little Elm, TX (US)

(73) Assignee: Frito-Lay North America, Inc., Plano, TX (US)

(21) Appl. No.: 14/032,307

(22) Filed: Sep. 20, 2013

(51) Int. Cl. G09F 3/00; G09F 3/10

(52) U.S. Cl. CPC G09F 3/0288; G09F 3/10
USPC 428/43

(57) ABSTRACT

A label and method for applying same. The label has a remaining portion having a front face, a back face, and an adhesive. The label also has a detachable portion removably coupled to the remaining portion via a weakened connection. The detachable portion has a front face, a back face, and a non-adhesive. Thus, a consumer can remove the detachable portion from the remaining portion via the weakened connection. The method includes obtaining the label, applying an adhesive, applying a non-adhesive, and affixing the label to the product whereby the detachable portion of the label can be detached.

### BACKGROUND OF THE INVENTION

Labels provide a useful means for communication. Labels can convey various information, including product description, advertisements, and warnings. Labels can be attached to numerous items in a variety of ways. Labels are often affixed to an article of commerce to communicate an advertisement. There exists a need for a better way to affix and distribute these labels.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 shows the front face of a label in one embodiment;

FIG. 2 shows the back face of a label in one embodiment;

FIG. 3 shows the back face of the detachable portion with an adhesive area on the lower portion in one embodiment;

FIG. 4 shows the back face of the detachable portion with adhesive areas located on the left and right edges of the detachable portion in one embodiment;

FIG. 5 shows the front face of a label in one embodiment;

FIG. 6 shows the front face of a label affixed to a product in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element that is not specifically disclosed herein.

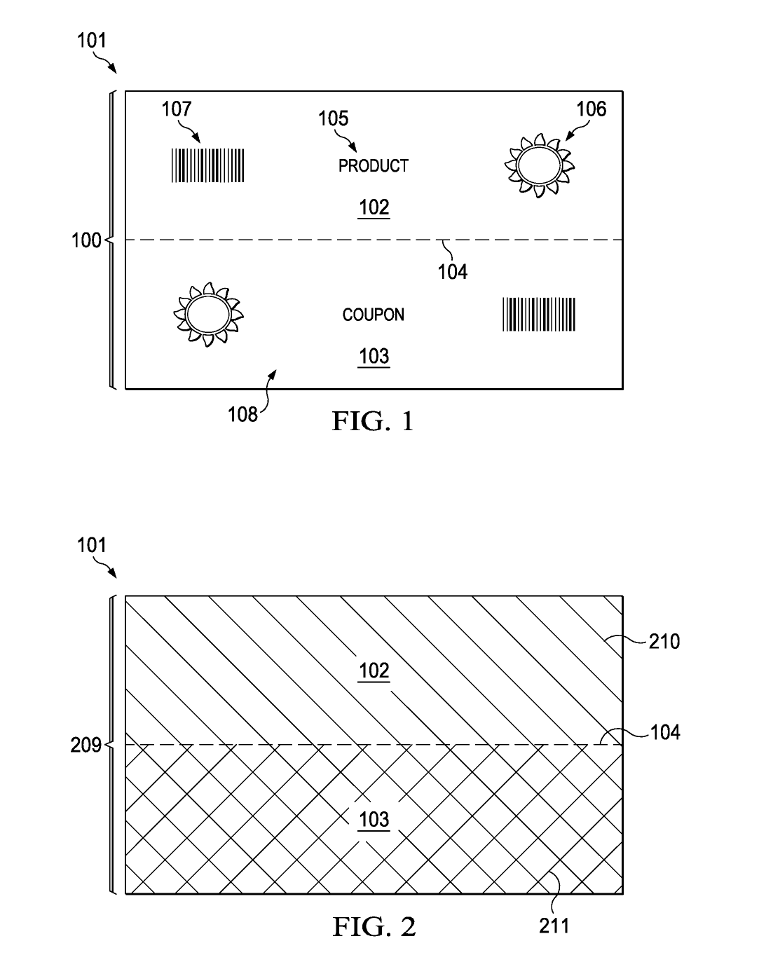

Various embodiments relate to a label 101 with a detachable portion 103. For example, FIG. 1 shows the front face 100 of a label 101 in one embodiment. In this embodiment, the label 101 comprises a remaining portion 102, a detachable portion 103, and a weakened connection 104. As used herein, a “label” 101 is anything that can be affixed to an article of commerce to communicate information such as product description, advertisements, and warnings. A label 101 can include any material, including but not limited to paper, polypropylene, plastic, cloth, film, metallic film, thermal label stock, thermal transfer ribbon, etc., and combinations thereof.

The label 101 can be made from a single-layer material or from a material with multiple layers. In one embodiment, the label 101 comprises a material made of a plurality of substrates, wherein the substrates are permanently adhered such that the substrates form a single layer. As used herein, a “single layer” can refer to one layer, but it can also refer to more than one layer wherein the layers are permanently adhered and look and function as if a single layer.

As depicted in FIG. 1, the remaining portion 102 is coupled to the detachable portion 103 via a weakened connection 104. As used herein, a “weakened connection” 104 refers to a connection that is weakened so that it can be separated by an ordinary consumer. Examples of a weakened connection 104 include perforation lines, scoring lines, double perforation lines, and double scoring lines. Another example of a weakened connection 104 includes striped lamination whereby, for example, a laminate which normally has three layers only has two at the weakened connection.

In one embodiment, the perforation line is led with a cut line. This means, as can be seen in FIG. 1, that the perforation line comprises a cut which extends to the edge of the label 101. A cut line which extends to the edge of the label 101 assists in the propagation of the tear and ensures that the tear occurs at the desired location, specifically the perforation line or lines. In one embodiment, the perforation line is led with a cut of about 1 mm to about 3 mm in length. In one embodiment standard perforations are used whereas in other embodiments micro-perforations can be used.

As noted above, in one embodiment two or more weakened connections 104 are utilized. Having two or more weakened connections 104 helps the tear propagate in the desired location. If upon tearing, the tear line leaves one weakened connection 104 and begins to tear along the label where there is no weakened connection 104, then the tear line will intersect a second weakened connection 104. Given that the weakened connection 104 is a path of least resistance, having two or more weakened connections 104 decreases the possibility that a label will be torn in an undesired location.

While a perforation line has been described, the weakened connection 104 is not so limited. In another embodiment, the weakened connection 104 comprises a scoring line or a plurality of scoring lines. A scoring line acts like a perforation line previously described and provides decreased resistance to ensure that a tear propagates in the desired location. Score lines can be created with any method known in the art, including but not limited to, chemical reactions, mechanical scoring, scoring via laser, etc. In one embodiment, the weakened connection 104 forms a line that is approximately straight. Thus, for example, in one embodiment, and as depicted in FIG. 1, the remaining portion 102 of the label 101 and the detachable portion 103 form shapes that are approximately rectangular. In other embodiments, the weakened connection 104 forms a line that is non-linear or complex. In these embodiments, the remaining portion 102 and detachable portion 103 can form a shape that is approximately a regular polygon, a quadrilateral, circular, elliptical, a complex polygon, or an irregular polygon. In other embodiments, the weakened connection 104 forms a plurality of lines, forming various shapes. Those skilled in the art will understand that various modifications can be made to the number of weakened connections 104, to the shape of the remaining portion 102 and the detachable portion 103, and to the number or remaining portions 102 and detachable portions 103 without departing from the spirit and scope of the these embodiments.

In the embodiment presented in FIG. 1, the remaining portion 102 comprises any message typically associated with a label 101. Examples of remaining portions 102 include a printed message 105, an image 106, a barcode 107, or any combination of these.

As depicted in FIG. 1, the detachable portion 103 comprises a ticket 108. As used herein, a “ticket” 108 is any item that can be used when separated from a label 101. Examples of a ticket 108 include a coupon, a promotional game piece, an advertisement, a marker, a tag, a token, a warning, an instruction, a collectible item, a recipe, etc.

It often is beneficial to place a ticket 108 on the front face 100 of a product. Such placement can more easily influence a potential purchaser at the point of sale than if the ticket 108 is placed on the product in another location. In such embodiments, because the ticket 108 is located on the front face of the product, the customer can better see the ticket 108. This is an advantage over embodiments wherein a coupon, for example, is placed on a back or side facing label.

In one embodiment the removable portion 103 is integrally made with the product label 101. As used herein, two portions are “integrally made” if they are manufactured as a single body and look and function as if a single body. An integrally made ticket 108 and label 101 decreases capital costs, decreases manufacturing costs, simplifies the manufacturing process, and increases the speed of production. When a ticket 108 is not integrally made, a product manufacturer must purchase a separate ticket 108 and must have a separate application station to affix the ticket 108 to the product. An integrally made label 101 and ticket 108 greatly simplifies the packaging process.

In one embodiment, the detachable portion 103 and the remaining portion 102 are integrally made and then a weakened connection 104 is added to the label 101 such that the detachable portion 103 and remaining portion 102 are removably coupled. The weakened connection 104 can be added before label printing or after label printing.

In some embodiments the detachable portion 103 is of a sufficient size such that the detachable portion 103 is large enough that it can be easily read. In addition, it can be beneficial for the detachable portion 103 to be of sufficient size that it can convey certain information. Thus, in one embodiment, the detachable portion 103 comprises greater than about 25% of the total surface area of the label 101. In another embodiment, the detachable portion 103 comprises more than about 50% of the total surface area of the label 101.

FIG. 2 shows the back face 209 of a label 101 in one embodiment. In the embodiment depicted in FIG. 2, the back face 209 of the label 101, including the remaining portion 102 and the detachable portion 103, comprises an adhesive 210. As depicted, the entire back face 209 comprises an adhesive. In some embodiments it is beneficial for the entire back face 209 of the label 101 to comprise an adhesive 210 because it can be cheaper and quicker to apply an adhesive 210 to the entire back face 209 of the label 101 rather than determining specific regions of the label 101 in which adhesive 210 will be and will not be applied. Thus, in some embodiments over 75% of the back label face 209 surface area comprises an adhesive. In other embodiments over 90% of the back label face 209 surface area comprises an adhesive.

As used herein, an “adhesive” 210 is any substance that allows one surface to adhere to another surface. Examples of an adhesive 210 include but are not limited to a pressure sensitive adhesive, a hot-melt adhesive, a water-activating adhesive, a thermoplastic adhesive, a wet glue, and a water moistenable gummed adhesive. In one embodiment the label 101 itself can act as an adhesive. For example, if the label 101 is plastic, the label 101 can be heat sealed against a container. In still other embodiments, an adhesive is a separate material which is applied to label to affix the label 101 to a product.

In one embodiment, and as depicted in FIG. 2, the same adhesive 210 is applied to the remaining portion 102 and the detachable portion 103. This promotes efficiency and decreases costs as a single adhesive can be applied to the entire label. However, in another embodiment dissimilar adhesives are utilized. For example, a first adhesive is applied in the remaining portion 102 whereas a second adhesive is applied in the detachable portion 103. In one embodiment, the first and second adhesives comprise different strengths. As an example, the second adhesive in the detachable portion 103 can be weaker than the first adhesive in the remaining portion 102, such that the detachable portion 103 is removably adhered while the remaining portion 102 is permanently adhered.

As mentioned above, it is often cheaper and quicker to apply an adhesive 210 universally to the entire label 101. However, so that the detachable portion 103 can be detached, the back face 209 of the detachable portion 103 in certain embodiments comprises an adhesive 210 and a non-adhesive 211, as depicted in FIG. 2.

As used herein, a “non-adhesive” refers to any substance that deactivates or covers an adhesive rendering the adhesive inactive. Various non-adhesives 211 can be used, such as resin varnish, acrylic varnish, waterborne varnish, spirit varnish, oil varnish, drying oil, lacquer, polyurethane varnish, and epoxy varnish. In one embodiment the non-adhesive comprises another layer of film which covers the adhesive rendering it inactive.

A non-adhesive 211 on the detachable portion 103 weakens or deactivates the adhesive such that the detachable portion 103 is not permanently adhered to the product. Thus, the non-adhesive 211 allows the detachable portion 103 to be removed while allowing the remaining portion 102 to remain adhered to the container. The consumer can then use the detachable portion 103 in the desired manner such as redeeming as a coupon, raffle, etc.

As depicted in FIG. 2, the entire label, including the remaining portion 102 and the detachable portion 103, is covered by an adhesive 210. Further, as depicted, the entire detachable portion 103 is covered with a non-adhesive 211. This embodiment, however, is not so limiting. In other embodiments, as will be discussed in more detail below, the non-adhesive 211 is not applied to the entire detachable portion 103 leaving some adhesive 210 activated. Further, in some embodiments, the non-adhesive 211 can be pattern applied to deactivate sufficient adhesive to allow the detachable portion 103 to be detachable. Thus, for example, rather than the non-adhesive 211 covering the entire detachable portion 103 as depicted in FIG. 2, only portions of the detachable portion 103 comprise non-adhesive 211 and there are portions of exposed adhesive 210.

In the embodiment presented in FIG. 2, the back face 209 of the detachable portion 103 further comprises a ticket 108. In one embodiment it is beneficial for both the front face 100 and the back face 209 of the detachable portion 103 to comprise a ticket 108 because it increases the amount of surface area available to communicate information. Thus, in certain embodiments, the back face 209 of the detachable portion 103, like the front face 100 of the remaining portion 102, comprises a printed message 105, an image 106, a barcode 107, or any combination previously described.

In some embodiments, one problem that occurs when the detachable portion 103 comprises a non-adhesive 211 is that the detachable portion 103 can curl up, creating an appearance that is undesirable. This is exacerbated when the label is applied hot because as the label cools it retracts. Because in some embodiments the detachable portion 103 is not adhered due to the non-adhesive 211, the detachable portion 103 retracts and curls as it cools. Further, an additional problem is if the corners and edges are not adhered, the corners and edges can be unintentionally snagged to initiate a tear. To overcome these problems, in some embodiments, the non-adhesive 211 is not applied to the entire back face 209 of the detachable portion 103. Thus, not all of the adhesive 210 on the back face 209 of the detachable portion 103 is deactivated.

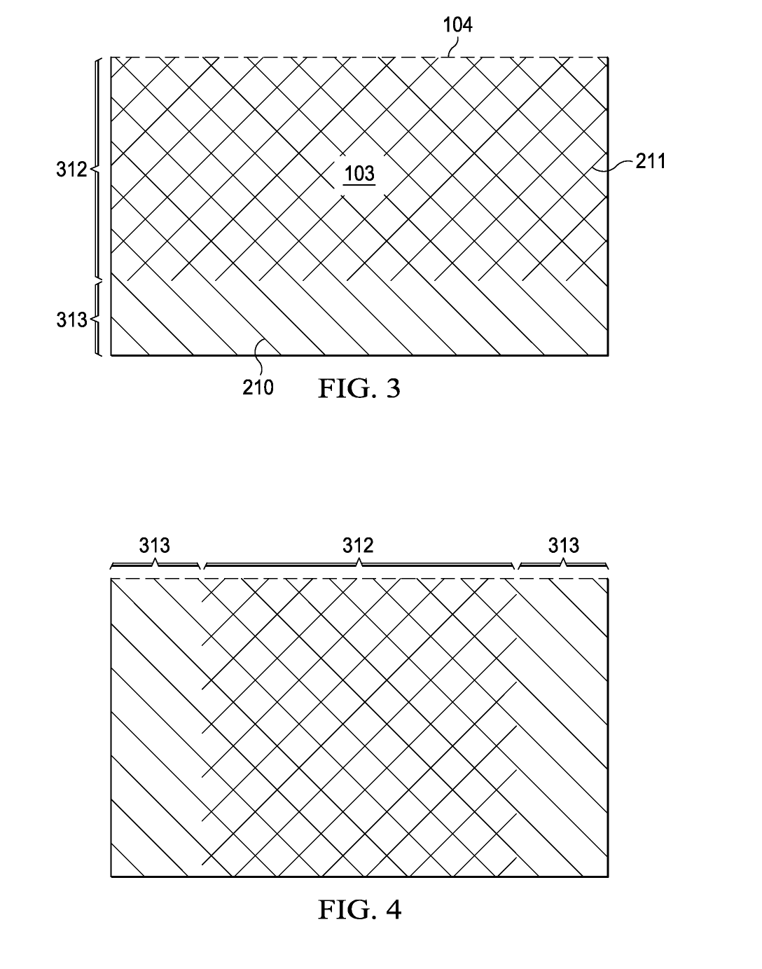

FIG. 3 shows the back face of the detachable portion with an adhesive area on the lower portion in one embodiment. In this embodiment, the detachable portion 103 comprises a non-adhesive area 312 which comprises a non-adhesive, and an adhesive area 313 which does not comprise a non-adhesive. As depicted, the non-adhesive area 312 is located closest to the weakened connection and is above the adhesive area 313. The adhesive area 313, as shown, comprises a line along the lower edge of the detachable portion 103. This arrangement is for illustrative purposes only and should not be deemed limiting. The non-adhesive area 312 in this embodiment comprises an adhesive 210 and a non-adhesive 211 located atop the adhesive 210. The non-adhesive area 312 is the portion of the detachable portion 103 which is not adhered to the product. Also depicted, the adhesive area 313 in this embodiment comprises an adhesive 210 but does not comprise a non-adhesive 211. In one embodiment, the adhesive 210 in the adhesive area 313 of the detachable portion 103 has not been deactivated. This adhesive 210 adheres the adhesive area 313 to the product and decreases and/or eliminates curling due to unintentional snags and cooling. In one embodiment the surface area of the adhesive area 313 provides sufficient adhesion to prevent curling but not so much adhesion as to prevent the detachable portion 103 from detaching. Thus, in one embodiment the adhesion force provided by the adhesive area 313 can be easily broken by a customer wishing to detach the detachable portion 103. The thickness of the adhesive area 313 can vary by application. Thicknesses lower than a millimeter and larger than ½ of an inch can be utilized. In one embodiment the adhesive area 313 comprises a thickness of ⅛ of an inch.

In some embodiments the surface area of the adhesive area 313, the portion of the detachable portion 103 which remains adhesive, is minimized to prevent the detachable portion 103 from becoming permanently adhered to the product or from undesirably preventing the detachable portion 103 from becoming detachable. Thus, in one embodiment, the non-adhesive area 312 of the detachable portion 103 of the label 101 comprises at least about 80% of the surface area of the detachable portion 103. In another embodiment, the non-adhesive area 312 comprises at least about 90% of the surface area of the detachable portion 103. In another embodiment, the non-adhesive area 312 comprises at least about 95% of the surface area of the detachable portion 103.

While FIG. 3 shows the adhesive area 313 located as a line along the lower edge of the detachable portion 103, this example is for illustrative purposes and should not be deemed limiting. The adhesive area 313 of the detachable portion 103 can be located in a variety of places. FIG. 4 shows the back face of the detachable portion with adhesive areas 313 located on the left and right edges of the detachable portion. As depicted, the non-adhesive area 312 is in the middle and is flanked by two adhesive areas 313 on either side. The selective application of the non-adhesive 211 as demonstrated in FIG. 4 prevents the detachable portion 103 from experiencing curl-up while still allowing the detachable portion 103 to be easily removed by an ordinary consumer. While FIGS. 3 and 4 have shown embodiments wherein the adhesive areas 313 are located along an edge, these locations are for illustrative purposes only and should not be deemed limiting. For example, the selective application of non-adhesive 211 can be utilized in the corners to prevent curling. In such embodiments, only the corners will comprise an adhesive area 313 whereas the other portions of the detachable portion 103 comprise a non-adhesive area 312. Taken further, while FIGS. 3 and 4 have illustrated a linear shape for the adhesive area 313, this shape is not limiting. The adhesive area 313 and the non-adhesive area 312 can comprise virtually any shape.

Returning back to FIG. 3, while an embodiment showing the adhesive portion 313 and the non-adhesive portion 312 having the same adhesive 210 have been described, separate adhesives are utilized in some embodiments. For example, a first adhesive is applied in the adhesive area 313 while a second dissimilar adhesive is applied in the non-adhesive area 312. In one embodiment, the first and second adhesives comprise different strengths. As an example, the second adhesive applied in the non-adhesive portion 313 can be weaker than the first adhesive applied in the adhesive area 313, such that the adhesive area 313 is more difficult to remove than the non-adhesive area 312 to prevent curling and accidental tearing.

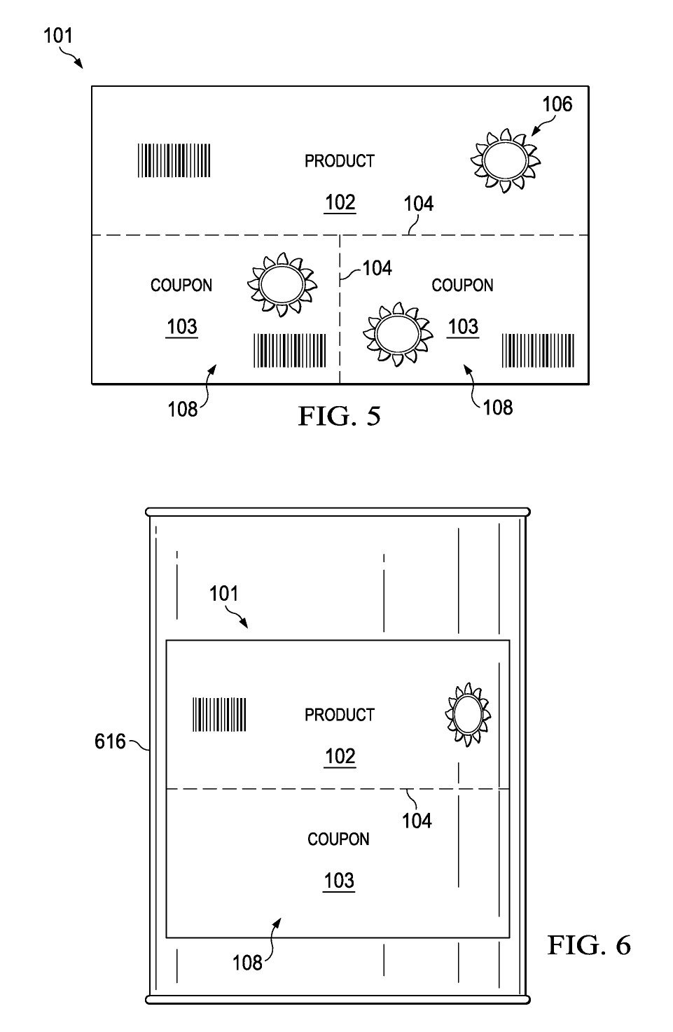

In one embodiment the label 101 comprises a plurality of detachable portions 103. FIG. 5 shows the front face 100 of one embodiment. In this embodiment, a label 101 comprises a remaining portion 102, two detachable portions 103, and three weakened connections 104. In this embodiment, each detachable portion 103 comprises a ticket 108. While an embodiment showing a label 101 comprising two detachable portions 103 has been described, a label 101 comprises a plurality of detachable portions 103 in another embodiment. In one embodiment, the detachable portions 103 are positioned such that they share one or more weakened connections 104. In another embodiment, the detachable portions 103 do not share a weakened connection 104.

FIG. 6 shows the front face 100 of one embodiment. In this embodiment, a label 101 is affixed to a product 616. As used herein, a “product” 616 is any article of commerce upon which a label 101 can be affixed. Examples of a product 616 include but are not limited to non-packaged goods, such as fruit, vegetables, or other produce, and packaged goods, such as cans, containers, jars, bags, and bottles.

In one embodiment, the label is affixed to a product 616 so as to act as a security device which shows when a product has been opened. For example, in one embodiment the detachable portion 103 is positioned over the lid. When the detachable portion 103 has been removed, this demonstrates that the package has been opened. This embodiment is suitable for virtually any type of product including software, food, pharmaceuticals, etc.

As noted above, in one embodiment the detachable portion 103 is located on the front label 101, a customer is more likely to see and utilize the detachable portion 103 compared to embodiments wherein a coupon, for example, is on the back or side faces of the package which are not visible. Consequently, locating a detachable portion 103 on the front face of a package increases visibility, and therefore distribution of the detachable portions 103.

The first step in increasing distribution of a coupon is obtaining a label 101 as previously described. Thereafter, an adhesive is applied. In one embodiment, the step of applying an adhesive 210 comprises applying the adhesive 210 to the label 101. In another embodiment, the step of applying an adhesive 210 comprises applying the adhesive 210 to the product 616. As noted, in one embodiment the same adhesive is applied to the remaining portion and the detachable portion.

Next, a non-adhesive 211 is applied. The non-adhesive 211 can be applied to the label or to the product. In one embodiment the entire detachable portion 103 is coated with a non-adhesive 211. In other embodiments, however, portions of the detachable portions 103 are not coated with a non-adhesive resulting in an adhesive area 313. In one embodiment the non-adhesive 211 is applied atop the adhesive 210.

Thereafter, the label 101 is affixed to a product 616. In one embodiment the affixing step comprises affixing such that the remaining portion 102 is permanently adhered to the product 616 and such the detachable portion 103 is removably adhered.

Finally, the product 616 is distributed. Consumers can detach the detachable portion 103 and redeem for the stated use. As noted, such method increases the distribution rate of the detachable portion.

As noted above, the method of distribution has several advantages. First, the redemption rates are increased compared to supplemental coupons which are affixed to the rear or sides of the containers. Redemption rates of coupons have increased by 3-4 times compared to traditional coupons. Further, because the coupon is integrated into the label, existing packaging machinery can be utilized. This reduces capital cost as additional equipment is not required.

While FIG. 6 shows an embodiment of one ticket 108 that can be distributed, the method of distributing a ticket 108 herein described applies to all of the labels 101, remaining portions 102, and detachable portions 103 previously described herein.

In one embodiment, the label 101 can be attached to a product 616 as a security device that shows when the product 616 has been opened, including products 616 such as a pharmaceutical bottle or a desktop computer. In another embodiment, the label 101 can be attached to a surface.

While the invention has been particularly shown and described with reference to a preferred embodiment, it will be understood by those skilled in the art that various changes in form and detail may be made therein without departing from the spirit and scope of the invention.

1. A label, comprising:
a remaining portion, wherein said remaining portion comprises a front face, a back face, and an adhesive; and
a detachable portion removably coupled to said remaining portion only by a weakened connection, wherein said detachable portion comprises a front face, a back face, and adhesive on an entire surface of the back face.

2. The label of claim 1 further comprising a surface area, wherein said remaining portion comprises at least about 75% of said surface area of said label.

3. The label of claim 1 wherein said detachable portion comprises a ticket.

4. The label of claim 1 wherein said front face of said detachable portion comprises a ticket and wherein said back face of said detachable portion comprises a ticket.

5. The label of claim 1 further comprising polypropylene.

6. The label of claim 1 wherein said adhesive comprises a pressure sensitive adhesive.

7. The label of claim 1 wherein said detachable portion further comprises an non-adhesive.

8. The label of claim 7 wherein said detachable portion comprises an adhesive area and a non-adhesive area, wherein the adhesive area and the non-adhesive area are both located on the back face.

9. The label of claim 7 wherein said non-adhesive is applied to only a portion of the adhesive.

10. The label of claim 1 wherein said weakened connection comprises a perforation line.

11. The label of claim 1 wherein said remaining portion and said detachable portion are integrally made.

12. A method of distributing coupons, said method comprising:
a) obtaining a label, wherein said label comprises:
a remaining portion, wherein said remaining portion comprises a front face and a back face; and
a detachable portion removably coupled to said remaining portion only by a weakened connection, wherein said detachable portion comprises a front face and a back face;
b) applying a first adhesive to an entire surface the back face of the detachable portion;
c) applying a non-adhesive to only part of the adhesive on the detachable portion;
d) affixing said label to a product, wherein said affixing step comprises affixing such that said remaining portion is permanently adhered to said product and such that said detachable portion is removably adhered; and
e) distributing said product with said attached label.

13. The method of claim 12 wherein said applying of step b) further comprises applying a second adhesive to said remaining portion.

14. (canceled)

15. The method of claim 12 wherein said applying of step c) comprises applying a varnish to said detachable portion.

16. The method of claim 12 wherein said applying of step c) comprises applying a non-adhesive to a portion of said detachable portion to create an adhesive area and a non-adhesive area.

17. The method of claim 13 wherein said applying of step b) comprises applying said adhesive to said label.

18. The method of claim 13 wherein said applying of step b) comprises applying said adhesive to said product.

19. The method of claim 12 wherein said obtaining of step a) further comprises affixing a weakened connection onto said label.

20. The method of claim 12 wherein said obtaining of step a) comprises obtaining a label wherein said weakened connection comprises a perforation line.
